(19) United States
(12) Patent Application Publication
(10) Pub. No.: US 2007/0205950 A1
(43) Pub. Date: Sep. 6, 2007

(54) ANTENNA ASSEMBLEY FOR USE IN WIRELESS COMMUNICATION

(75) Inventors: John E. McConnell, Ann Arbor, MI (US); John Stack, Shelby Township, MI (US); John S. Nantz, Brighton, MI (US); Jeffrey J. Battistella, Canton, MI (US)

Correspondence Address: BROOKS KUSHMAN P.C. / LEAR CORPORATION, 1000 TOWN CENTER, TWENTY-SECOND FLOOR, SOUTHFIELD, MI, 48075-1238, US

(73) Assignee: LEAR CORPORATION, Southfield, MI (US)

(21) Appl. No.: 11/276,570

(22) Filed: Mar. 6, 2006

(51) Int. Cl. H01Q 1/32

(52) U.S. Cl. 343/713

(57) ABSTRACT

An antenna assembly includes a plurality of antennas for use in wireless communication. A ganging member is provided for ganging the plurality of antennas in a substantially fixed relationship.

### TECHNICAL FIELD

The following relates to an antenna assembly for use in wireless communication.

A detailed description and accompanying drawing are set forth below.

### BRIEF DESCRIPTION OF THE DRAWINGS

FIG. 1 is a perspective view of the antenna assembly and described herein; and

FIG. 2 is a cross sectional view of the antenna assembly of FIG. 1, taken along line 2-2.

### DETAILED DESCRIPTION

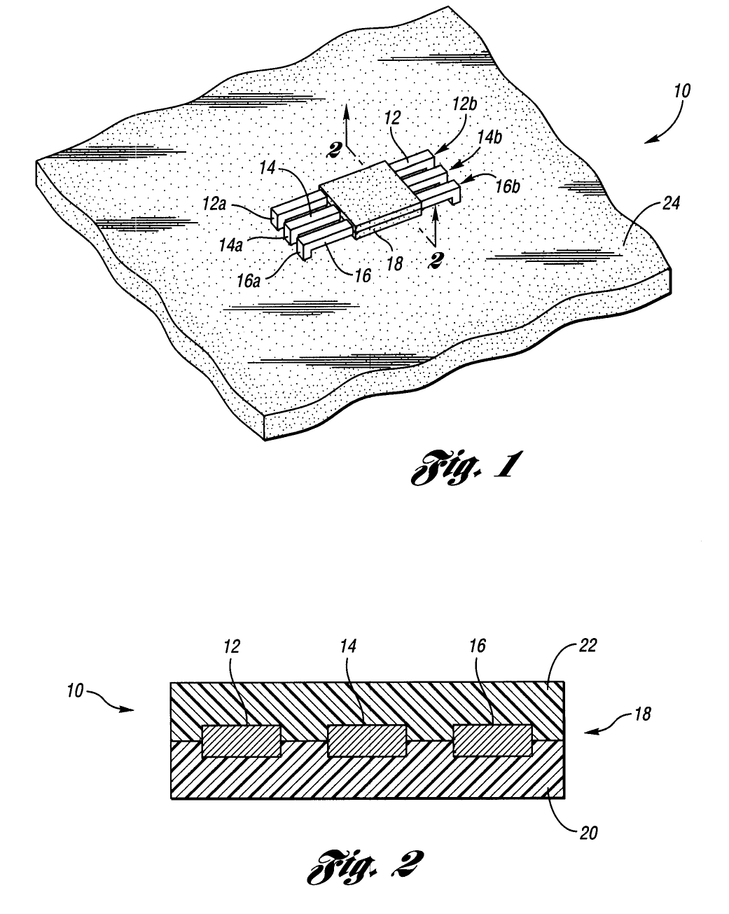

With reference to FIGS. 1 and 2, a more detailed description of the assembly will now be provided. It is increasingly common in automotive vehicles to use wireless communication systems for a variety of applications. These include, but are not limited to, remote keyless entry (RKE), tire pressure monitoring (TPM), remote control of garage door opening (GDO) systems, vehicle immobilzation, voice activated controls, and others.

Many of these communication systems, whether they include a transmitter, receiver, or transceiver, may be designed to operate in multiple frequency bands. As a result, such communication systems may utilize multiple antennas for transmitting and/or receiving wireless signals in such multiple frequency bands.

Where multiple antennas are utilized, the antennas must be placed one at a time on a circuit board during assembly or manufacture of the wireless system. As a result, each of the individual antennas must be designed to be stable enough to prevent rocking or falling over during the process of attachment of the antenna to the circuit board.

Moreover, individual attachment of multiple antennas to the circuit board also increases assembly time and cost, and creates potential problems associated with handling, placement and stability of the antennas prior to attachment to the circuit board. Still further, space on the circuit board is limited, and individual attachment of multiple antennas to the board decreases the ability to place the antennas in close proximity and conserve board space.

Thus, there exists a need for an antenna assembly for use in a wireless communication system, such as for automotive applications including RKE, TPM, remote control of GDO systems, vehicle immobilization, voice activated controls, and the like, that overcomes these problems. Such an assembly would allow for multiple antennas to be placed substantially simultaneously on a circuit board during assembly or manufacture of the wireless system. Such an assembly would thereby decrease assembly time and cost, ease handling of the antennas prior to attachment to the circuit board, and allow for high density placement of the multiple antennas on the circuit board.

Referring now more specifically to FIG. 1, a perspective view of the antenna assembly described herein is shown, denoted generally by reference numeral 10. The antenna assembly (10) may be for use in multi-frequency applications, particularly automotive applications such as RKE, TPM, remote control of GDO systems, vehicle immobilization, voice activated controls, or the like. The assembly (10) allows for the use of a single transmitter, receiver or transceiver circuit for multiple frequency operating requirements (although more than one transmitter, receiver or transceiver circuits could also be used), and provides multiple antennas for optimizing performance in different frequency bands.

As seen in FIG. 1, a plurality of antennas (12, 14, 16) for use in wireless communication are provided. It should be noted that while three antennas (12, 14, 16) are shown, any number of antennas may be used or provided. Each of the antennas (12, 14, 16), all of the antennas (12, 14, 16), or any one or combination of the antennas (12, 14, 16) may be for use in transmitting and/or receiving wireless signals. In that regard, and as noted above, the antennas (12, 14, 16) may be for use in any number of automotive applications utilizing wireless communication including, but not limited to, RKE, TPM, remote control of GDO systems, vehicle immobilization, voice activated controls, or the like.

Referring still to FIG. 1, the antennas (12, 14, 16) are ganged together by a ganging member (18) in a substantially fixed relationship. Although not required, in ganging the antennas (12, 14, 16) together, the ganging member (18) may encapsulate at least a portion of each of the antennas (12, 14, 16). Alternatively, the ganging member (18) may encapsulate substantially all of each of the antennas (12, 14, 16) (not shown). However, the ganging member (18) need not encapsulate the antennas (12, 14, 16) in any way. Instead, the ganging member (18) need only gang the antennas (12, 14, 16) in a substantially fixed relationship.

The antennas (12, 14, 16) may be ganged together by the ganging member (18) according to any insert molding process well known to those of ordinary skill in the art. Alternatively, the antennas (12, 14, 16) may be ganged together by the ganging member (18) according to any potting process well known to those of ordinary skill in the art. Once again, in such processes, the ganging member (18) may encapsulate the antennas (12, 14, 16), although encapsulation is not required.

Referring now to FIG. 2, a cross sectional view is shown of the antenna assembly (10) of FIG. 1, taken along line 2-2. In that regard, the same reference numerals used in FIG. 1 are used in FIG. 2 to refer to the same elements. As seen in FIG. 2, the ganging member (18) may comprise two pieces (20, 22). The antennas (12, 14, 16) may be positioned in one piece (22) of the ganging member (18), and the other piece (20) of the ganging member (18) may then be bonded to at least the first piece (22) of the ganging member (18).

In contrast to the antennas (12, 14, 16), which are comprised of a conductive material, the ganging member (18) is comprised of a non-conductive material. As a result, the ganging member (18) does not interfere with the transmission and/or reception of wireless signals by the antennas (12, 14, 16). It should also be noted that the antennas (12, 14, 16) may be ganged together by ganging member (18) at any distance from each other sufficient to allow for proper operation of the antennas (12, 14, 16) in a wireless communication system. In that regard, the dimensions between the individual antennas (12, 14, 16) in the antenna assembly (10) need not be the same.

As a result of the antennas (12, 14, 16) being ganged together by ganging member (18), the antenna assembly (10) may be attached to or installed on a circuit board as a unit. That is, by ganging the antennas (12, 14, 16) together, the ganging member (18) facilitates substantially simultaneous connection of the antennas (12, 14, 16) to a circuit board. Still further, the antenna assembly (10) also provides for high density placement of the antennas (12, 14, 16) on a circuit board. That is, by ganging the antennas (12, 14, 16) together, the ganging member (18) facilitates high density placement of the antennas on a circuit board.

In that regard, referring again to FIG. 1, each of the antennas (12, 14, 16) includes a pair of terminals (12a, 12b; 14a, 14b; 16a, 16b) for use in attaching the antenna (12, 14, 16) to a circuit board (24). Such attachment may be accomplished by soldering, although attachment may be undertaken according to any process or in any fashion known to those of ordinary skill in the art. It should also be noted that the antennas (12, 14, 16) may be ganged together by ganging member (18) at any distance from each other sufficient to allow for proper connection of the antennas (12, 14, 16) to the circuit board (24). In that regard, as an example only, each of the antennas (12, 14, 16) may be provided with a length of 35 mm and a height of 5 mm. The ganging member (18) may be provided with a width of 11.86 mm.

From the foregoing it can be seen that the antenna assembly (10) overcomes the problems described above concerning individual attachment of multiple antennas to the circuit board including increased assembly time and cost, handling, placement and stability of individual antennas prior to attachment to a circuit board, and the inability to place individual antennas in close proximity on a circuit board. More particularly, the antenna assembly (10) may be used in any wireless communication system, including such systems in automotive applications such as RKE, TPM, remote control of GDO systems, vehicle immobilization, voice activated controls, and the like. The antenna assembly (10) allows for multiple antennas (12, 14, 16) to be placed substantially simultaneously on a circuit board (24) during assembly or manufacture of the wireless system. The antenna assembly (10) thereby decreases assembly time and cost, eases handling of the antennas (12, 14, 16) prior to attachment to a circuit board (24), and allows for high density placement of the antennas (12, 14, 16) on a circuit board (24).

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. An antenna assembly comprising:
a plurality of antennas for use in wireless communication;
a ganging member for ganging the plurality of antennas in a substantially fixed relationship.

2. The assembly of claim 1 wherein the plurality of antennas are ganged in an insert molding process.

3. The assembly of claim 1 wherein the ganging member is insert molded to the plurality of antennas.

4. The assembly of claim 1 wherein the plurality of antennas are ganged in a potting process.

5. The assembly of claim 1 wherein the ganging member is potted to the plurality of antennas.

6. The assembly of claim 1 wherein the ganging member substantially encapsulates the plurality of antennas.

7. The assembly of claim 1 wherein the ganging member encapsulates a portion of each of the plurality of antennas.

8. The assembly of claim 1 wherein the plurality of antennas are for transmitting wireless signals.

9. The assembly of claim 1 wherein the plurality of antennas are for receiving wireless signals.

10. The assembly of claim 1 wherein the plurality of antennas are for transmitting and receiving wireless signals.

11. The assembly of claim 1 wherein at least one of the plurality of antennas is for transmitting wireless signals.

12. The assembly of claim 1 wherein at least one of the plurality of antennas is for receiving wireless signals.

13. The assembly of claim 1 wherein at least one of the plurality of antennas is for transmitting and receiving wireless signals.

14. The assembly of claim 1 wherein at least one of the plurality of antennas is for transmitting wireless signals and at least one of the plurality of signals is for receiving wireless signals.

15. The assembly of claim 1 wherein the ganging member comprises a two piece housing.

16. The assembly of claim 1 wherein the ganging member comprises a first piece and a second piece bonded to the first, the first and second pieces substantially encapsulating the plurality of antennas.

17. The assembly of claim 1 wherein the plurality of antennas are ganged to facilitate substantially simultaneous connection of the antennas to a circuit board.

18. The assembly of claim 1 wherein the plurality of antennas are ganged to facilitate high density placement of the antennas on a circuit board.

19. The assembly of claim 1 wherein the plurality of antennas are for use in an automotive application.

20. The assembly of claim 1 wherein the automotive application comprises a vehicle mounted transmitter.
